(19) United States
(12) Patent Application Publication
(10) Pub. No.: US 2015/0273600 A1
(43) Pub. Date: Oct. 1, 2015

(54) ELECTRO DISCHARGE MACHINING SYSTEM AND METHOD OF OPERATION THEREOF

(71) Applicant: APPLIED MATERIALS, INC., Santa Clara, CA (US)

(72) Inventor: Fatih Mert Ozkeskin, San Jose, CA (US)

(21) Appl. No.: 14/438,221

(22) PCT Filed: Oct. 25, 2013
(86) PCT No.: PCT/US13/66984

§ 371 Date: Apr. 23, 2015

Related U.S. Application Data
(60) Provisional application No. 61/718,698, filed on Oct. 25, 2012.

(51) Int. Cl. B23H 1/04; B23H 7/26; B23H 9/18; B23H 11/00

(52) U.S. Cl. CPC B23H 1/04; B23H 11/003; B23H 7/26; B23H 9/18

(57) ABSTRACT

An electro discharge machining system, and method of manufacture therefor, providing: an electro discharge machining unit and control; a workpiece holder; a tool having an electrode array formed of a plurality of geometrically shaped electrodes; and wherein the workpiece holder and the tool holder are operatively connected to the electro discharge machining unit and control for batch electro discharge machining of a workpiece to a configuration having a plurality of geometrically shaped structures.

### CROSS-REFERENCE TO RELATED APPLICATION(S)

This application claims the benefit of U.S. Provisional Patent Application Ser. No. 61/718,698 filed Oct. 25, 2012, and the subject matter thereof is incorporated herein by reference thereto.

### TECHNICAL FIELD

The present invention relates generally to an electro discharge machining system and more particularly to a system for utilizing a batch process in an electro discharge machining system.

### BACKGROUND

The rapidly growing market for portable electronic devices, e.g. cellular phones, laptop computers, and tablet computers, is an integral facet of modern life. The multitude of portable devices represents one of the largest potential market opportunities for next generation manufacturing. These devices have unique attributes that have significant impacts on manufacturing integration, in that they must be generally small, lightweight, and rich in functionality and they must be produced in high volumes at relatively low cost.

As an extension of the semiconductor industry, the electronics manufacturing industry has witnessed ever-increasing commercial competitive pressures, along with growing consumer expectations, and the diminishing opportunities for meaningful product differentiation in the marketplace.

Manufacturing, materials engineering, and development are at the very core of these next generation electronics insertion strategies outlined in road maps for development of next generation products. Future electronic systems can be more intelligent, have higher density, use less power, operate at higher speed, and can include mixed technology devices and assembly structures at lower cost than today.

There have been many approaches to addressing the advanced manufacturing requirements of microprocessors and portable electronics with successive generations of semiconductors. Many industry road maps have identified significant gaps between the current semiconductor capability and the available supporting electronic manufacturing technologies. The limitations and issues with current technologies include increasing clock rates, electromagnetic interference, thermal loads, second level assembly reliability stresses and cost.

As these manufacturing systems evolve to incorporate more components with varied environmental needs, the pressure to push the technological envelope becomes increasingly challenging. More significantly, with the ever-increasing complexity, the potential risk of error increases greatly during manufacture.

In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Thus, a need remains for smaller footprints and more robust methods for manufacture. Solutions to these problems have been long sought but prior developments have not taught or suggested any solutions and, thus, solutions to these problems have long eluded those skilled in the art.

### SUMMARY

The present invention provides a method of manufacturing an electro discharge machining system including: providing an electro discharge machining unit and control; providing a workpiece holder; providing a tool holder for a tool having an electrode array formed of a plurality of geometrically shaped electrodes; and operatively connecting the workpiece holder and the tool holder to the electro discharge machining unit and control for batch electro discharge machining of a workpiece to a configuration having a plurality of geometrically shaped structures.

The present invention provides an electro discharge machining system including: an electro discharge machining unit and control; a workpiece holder; a tool having an electrode array formed of a plurality of geometrically shaped electrodes; and wherein the workpiece holder and the tool holder are operatively connected to the electro discharge machining unit and control for batch electro discharge machining of a workpiece to a configuration having a plurality of geometrically shaped structures.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a cross-sectional view of an electro discharge machining system in an embodiment of the present invention.

FIG. 2 is a magnified view of section A of the electro discharge machining system of FIG. 1.

FIG. 3 is a magnified view of section A of the electro discharge machining system of FIG. 1 after a movement of the X-Y stage.

FIG. 4 is a magnified view of section A of the electro discharge machining system of FIG. 1 during a discharge phase of manufacture.

FIG. 5 is a magnified view of section A of the electro discharge machining system of FIG. 1 during a discharge phase of manufacture.

FIG. 6 is a magnified view of section B of FIG. 5 after a discharge phase of manufacture.

FIG. 7 is a magnified view of section C of FIG. 6 showing pyramids.

FIG. 8 is a cross-sectional schematic of light falling on regular pyramids.

FIG. 9 is an isometric view of a photo-voltaic device.

FIG. 10 is a flow chart of a method of operation of the electro discharge machining system in a further embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes can be made without departing from the scope of the present invention.

In the following description, numerous specific details are given to provide a thorough understanding of the invention. However, it will be apparent that the invention can be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. In addition, where multiple embodiments are disclosed and described having some features in common, for clarity and ease of illustration, description, and comprehension thereof, similar and like features one to another will ordinarily be described with similar reference numerals.

For expository purposes, the term “horizontal” as used herein is defined as a plane parallel to the plane of a top surface of the workpiece, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures. The term “on” means that there is direct contact between elements without having any intervening material. The term “processing” as used herein includes deposition of material or photoresist, patterning, exposure, development, etching, cleaning, and/or removal of the material or photoresist as used in forming a described structure.

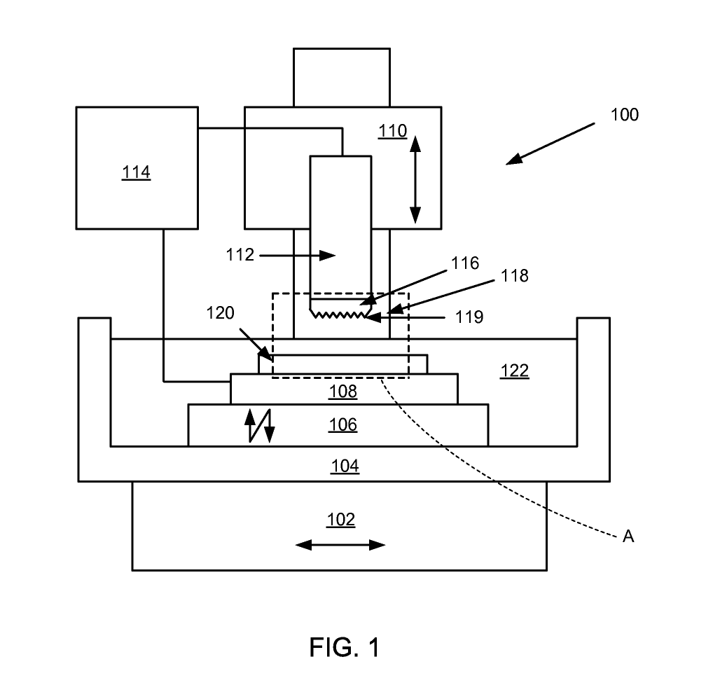

Referring now to FIG. 1, therein is shown a cross-sectional view of an electro discharge machining system 100 in an embodiment of the present invention. One embodiment of the present invention uses micro-electro discharge machining (Micro-EDM), which is a heat driven disruptive technology for nano-scale selective material removal.

The electro discharge machining system 100 has an X-Y stage 102 for moving a container 104 in X and Y directions. The X-Y stage 102 provides X-Y motion up to approximately 500 mm in length and 10 nm in resolution. The Z stage 110 provides Z motion approximately 150 mm in 1 nm resolution.

The container 104 supports a vibrator 106 capable of imposing small X, Y, and/or Z motions on a workpiece holder 108. In one embodiment, the small vibrations are in the X-Y directions and are around <1 nm to facilitate particle escape from the machining zone.

Supported above the workpiece holder 108 is a Z stage 110 for moving a tool holder 112 in the Z direction.

A Micro-EDM unit and control 114 is connected between the workpiece holder 108 and the tool holder 112 to electrically connect to a workpiece 120 and to a tool 116, respectively. The workpiece holder 108 is designed for easy and rapid replacement of the tool 116.

As shown, the tool 116 is sized smaller than the work piece 120 in which the stage is moved in X and Y directions to position the work piece under the tool.

In other embodiments, the tool may be mounted on an X-Y stage to position the tool over the work piece.

In other embodiments, the tool 116 may be of similar size of the work piece obviating the need for an X-Y stage.

In other embodiments, multiple tools 116 may be mounted to the tool holder 112.

In other embodiments, the stage 102 may provide the Z-motion.

To increase the throughput of the system 100, the system 100 includes a spare tool that is quickly exchanged by the tool holder 112 to replace worn out tools.

In other embodiments, the system 100 may include an additional post-clean station which cleans and/or removes particles created from the work piece created from the micro-EDM process.

The electro discharge machining system 100 is shown having the tool 116 with at least one electrode array 118 that can be a cathode brought into very close proximity, 1 nm to 100 nm, with the workpiece 120.

The workpiece 120 can be an anode submerged in a fluid 122 held by the container 104. The fluid 122 can be a dielectric fluid or chemical fluid. For example, the chemical fluid can be utilized for an electrochemically assisted discharge machining using NaNO₃ or similar chemicals. A spark discharge occurs between the electrode array 118 of the tool 116 and the workpiece 120 and thermally erodes the workpiece 120 in the configuration of the electrode array 118.

For example, the electrode array 118 has a plurality of geometric structures, such as pyramids 119, and can be fabricated in a single step lithographic process and repeatedly used to batch machine the shape of the workpiece 120. The purpose of the pyramids 119 is to create special features on the surface of the workpiece 120, such as inverted pyramids. It should be noted that other geometrical shapes may be formed in the tool 116 to form other geometrical shapes in the workpiece 120.

With different geometric structures having different horizontal cross-sections as the electrode array 118 moves vertically, the speed of machining needs to be changed to remove smaller or larger areas. It has been discovered that the volume of material removed per second can be kept constant and the stage 102 moved at different speeds. For example, for the pyramids 119, the electrode array 118 would be moved more slowly to remove larger volumes of material.

It has been discovered that utilizing the electro discharge machining system 100 having the tool to work on the workpiece 120 forming the pyramids, eliminates the need for masks and patterning of the workpiece 120, and provides an inexpensive and reliable process for creating features with sizes down one micron in a variety of workpieces. It has been further discovered that the electro discharge machining system 100 can increase throughput, and surface quality by enhancing surface characteristics such as roughness, using the chemical fluid instead of the dielectric fluid. It has been further discovered that utilizing the electro discharge machining system 100 can reduce costs and increase throughput when utilized to create pyramids in a batch on the workpiece 120.

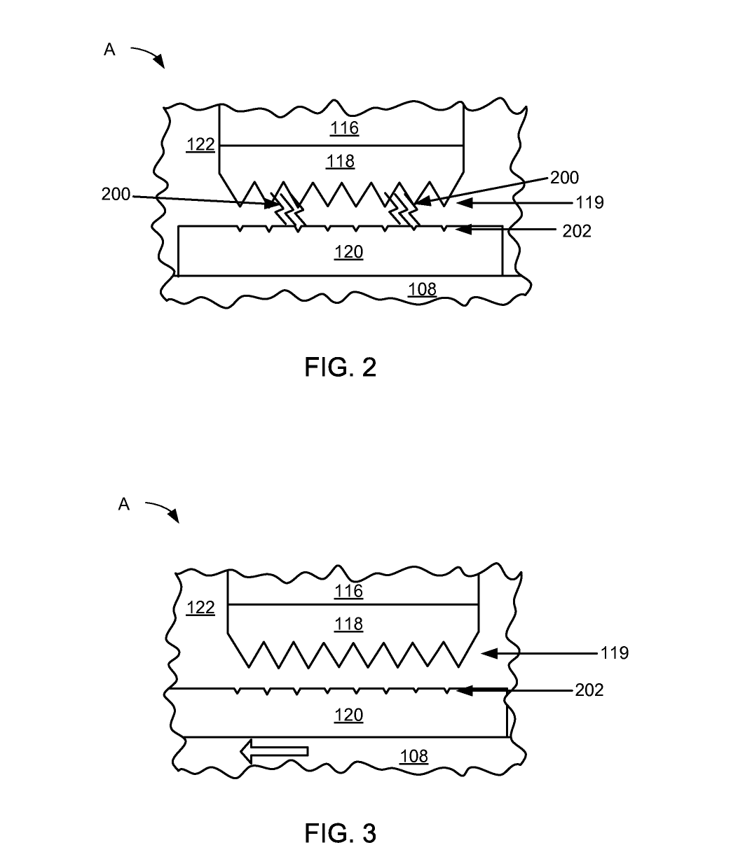

Referring now to FIG. 2, therein is shown a magnified view of section A of the electro discharge machining system 100 of FIG. 1 during a discharge phase of manufacture. The electro discharge machining system 100 is shown with having the tool 116 brought in close proximity with the workpiece 120. The fluid 122 is shown between the pyramids 119 and the workpiece 120.

Spark discharges 200 are shown through the fluid 122 and between the pyramids 119 and the workpiece 120 removing material from the workpiece 120 in the process. The tool 116 can be utilized to create pyramidal indentations 202 simultaneously as a batch of indentations. This batch-mode Micro-EDM is a technique where the tool 116 is lithographically fabricated and used repeatedly to fabricate repeated pyramidal indentations 202 in the workpiece 120. The depth of the pyramidal indentations 202 can be finely controlled through the use of the Z-stage 110 of FIG. 1. For silicon, the cubic crystalline structure assists in the formation of the pyramidal indentations.

Referring now to FIG. 3, therein is shown a magnified view of section A of the electro discharge machining system 100 of FIG. 1 after a movement of the X-Y stage 102. The workpiece 120 can be moved by the X-Y stage horizontally by distances less than 0.1 μm horizontally.

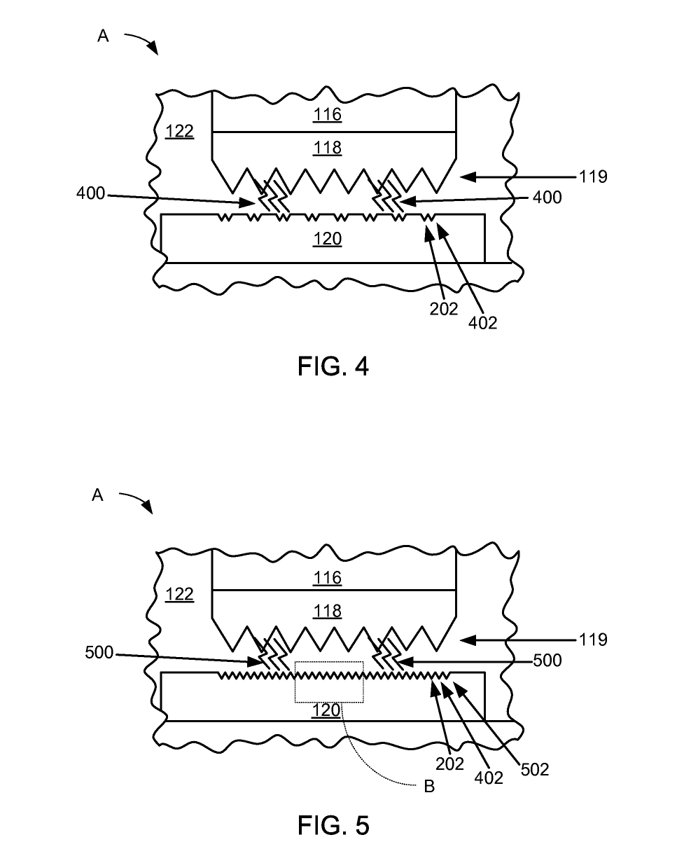

Referring now to FIG. 4, therein is shown a magnified view of section A of the electro discharge machining system 100 of FIG. 1 during a discharge phase of manufacture. Spark discharges 400 are shown through the fluid 122 and between the pyramids 119 and the workpiece 120 removing material from the workpiece 120 in the process. Pyramidal indentations 402 are formed in the surface of the workpiece 120 that are to one side of the pyramidal indentations 202.

Referring now to FIG. 5, therein is shown a magnified view of section A of the electro discharge machining system 100 of FIG. 1 during a discharge phase of manufacture. The workpiece 120 has been moved horizontally so spark discharges 500 form pyramidal indentations 502.

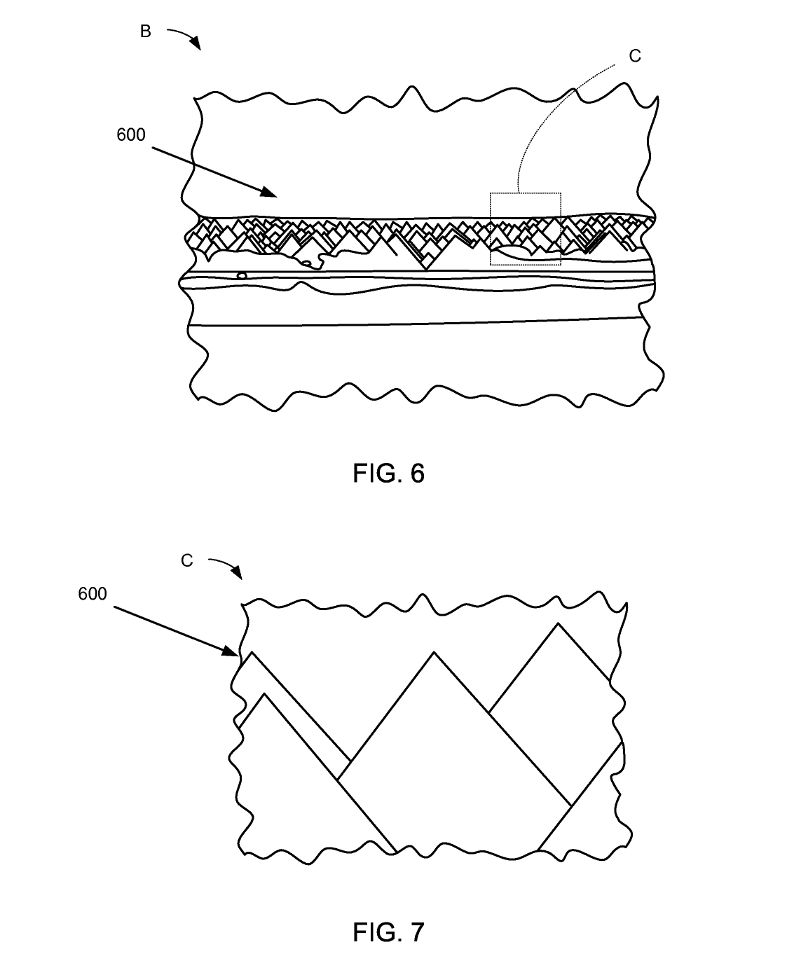

Referring now to FIG. 6, therein is shown a magnified view of section B of FIG. 5 after a discharge phase of manufacture. By use of the vibrator 106 of FIG. 1, pyramidal indentations can be made to overlap and have different depths to form pyramids 600 that are of different heights and spaces so as to be highly irregular. In photo-voltaic devices, the irregularity of the pyramids 600 is advantageous because the irregularity optimizes the number of bounces of a photon during light capture.

Referring now to FIG. 7, therein is shown a magnified view of section C of FIG. 6 better showing the pyramids 600.

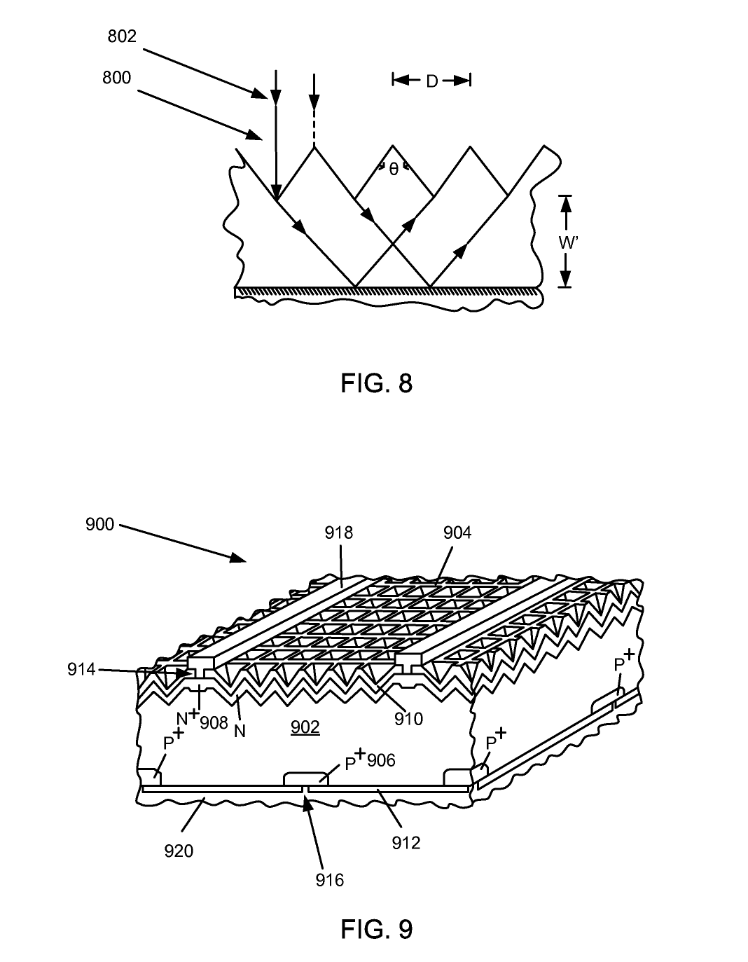

Referring now to FIG. 8, therein is shown a cross-sectional schematic of light falling on regular pyramids 800. For a photo-voltaic device, photons of light 802 falling on the regular pyramids 800 do not optimize the number of bounces of light for the best light capture.

Edge angles and the tip pitches for pyramids are important parameters for optimizing the number of bounces for light capture.

Referring now to FIG. 9, therein is shown an isometric view of a photo-voltaic device 900. A heavily doped silicon substrate 902 of P-silicon has inverted pyramids 904 formed simultaneously in the surface thereof by micro-EDM. The heavily doped silicon substrate 902 has P+ wells 906 in the bottom side and N+ implant 908 in the inverted pyramids 904 on top. Top and bottom oxide layers 910 and 912 are formed over the top and bottom with vias 914 and 916. Conductive fingers 918 and a rear contact 920 are patterned on top and bottom in respective contact with the N+ implant and P+ wells.

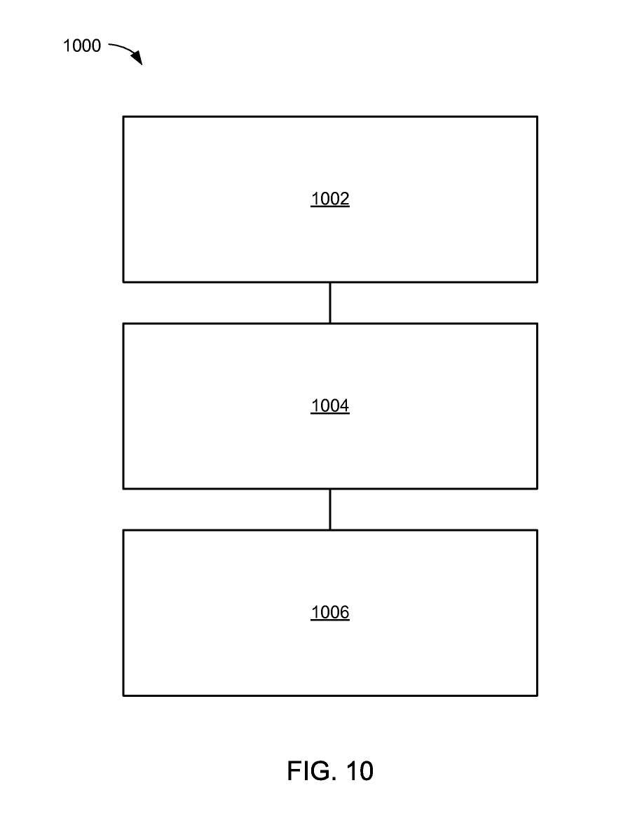

Referring now to FIG. 10, therein is shown a flow chart of a method of operation of the electro discharge machining system 100 in a further embodiment of the present invention. The method 1000 includes: providing a workpiece in a block 1002; moving a tool over the workpiece in a block 1004; and creating a spark discharge between the tool and the workpiece to create pyramids along a crystal lattice of the workpiece in a block 1006.

Thus, it has been discovered that the electro discharge machining system 100 and batch machining of the inverted pyramids of the present invention furnishes important and heretofore unknown and unavailable solutions, capabilities, and functional aspects for photo-voltaic device configurations. The resulting processes and configurations are straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

1. A method of manufacturing an electro discharge machining system comprising:
providing an electro discharge machining unit and control;
providing a workpiece holder;
providing a tool holder for a tool having an electrode array formed of a plurality of geometrically shaped electrodes; and
operatively connecting the workpiece holder and the tool holder to the electro discharge machining unit and control for batch electro discharge machining of a workpiece to a configuration having a plurality of geometrically shaped structures.

2. The method as claimed in claim 1 further comprising providing a vibrator for vibrating the workpiece and the tool relative to each other for electro discharge machining of the workpiece to have a multiplicity of geometric shaped structures different from a configuration of the electrode array.

3. The method as claimed in claim 1 further comprising providing a vibrator for vibrating the workpiece and the tool relative to each other for electro discharge machining of the workpiece to have a multiplicity of inverted geometric shaped structures different from a configuration of the electrode array.

4. The method as claimed in claim 1 further comprising providing a container for submerging the workpiece in a non-dielectric fluid.

5. The method as claimed in claim 1 further providing stages for the workpiece holder and the tool holder for moving the workpiece and the tool relative to each other for electro discharge machining of heavily doped silicon.

6. An electro discharge machining system comprising:
an electro discharge machining unit and control;
a workpiece holder;
a tool holder for a tool having an electrode array formed of a plurality of geometrically shaped electrodes; and
wherein the workpiece holder and the tool holder are operatively connected to the electro discharge machining unit and control for batch electro discharge machining of a workpiece to a configuration having a plurality of geometrically shaped structures.

7. The system as claimed in claim 6 further comprising a vibrator for vibrating the workpiece and the tool relative to each other for electro discharge machining of the workpiece to have a multiplicity of geometric shaped structures different from a configuration of the electrode array.

8. The system as claimed in claim 6 further comprising a vibrator for vibrating the workpiece and the tool relative to each other for electro discharge machining of the workpiece to have a multiplicity of inverted geometric shaped structures different from a configuration of the electrode array.

9. The system as claimed in claim 6 further comprising a container for submerging the workpiece in a non-dielectric fluid.

10. The system as claimed in claim 6 further comprising stages for the workpiece holder and the tool holder for moving the workpiece and the tool relative to each other for electro discharge machining of heavily doped silicon.

11. A method of manufacturing an electro discharge machining system comprising:
providing a micro electro discharge machining unit and control for providing and controlling an electro discharge;
providing a workpiece holder for holding a workpiece;
providing a tool holder for holding a tool having an electrode array including a plurality of pyramidal electrodes; and
operatively connecting the workpiece holder and the tool holder to the electro discharge machining unit and control for batch electro discharge machining of a workpiece to a configuration having a plurality of inverted pyramidal structures.

12. The method as claimed in claim 11 further comprising providing a vibrator for vibrating the workpiece and the tool relative to each other under 1 nm for electro discharge machining of a different pyramidal structure in the workpiece from a configuration of the electrode array.

13. The method as claimed in claim 11 further comprising providing a vibrator for vibrating the workpiece and the tool relative to each other at under 1 nm for electro discharge machining of a different inverted pyramidal structures in the workpiece from a configuration of the electrode array.

14. The method as claimed in claim 11 further comprising providing a container for submerging the workpiece and the tool in a non-dielectric chemical fluid.

15. The method as claimed in claim 11 further comprising providing an X-Y stage for the workpiece holder for moving a container for a silicon workpiece and a Z stage for the tool holder for moving the tool and the workpiece relative to each other for electro discharge machining down to distances less than 0.1 μm.

16. The system as claimed in claim 6 wherein the electrode array includes a plurality of pyramidal electrodes for batch electro discharge machining of the workpiece.

17. The system as claimed in claim 16 further comprising a vibrator for vibrating the workpiece and the tool relative to each other under 1 nm for electro discharge machining of a different pyramidal structure in the workpiece from a configuration of the electrode array.

18. The system as claimed in claim 16 further comprising a vibrator for vibrating the workpiece and the tool relative to each other under 1 nm for electro discharge machining of a different inverted pyramidal structure in the workpiece from a configuration of the electrode array.

19. The system as claimed in claim 16 further comprising a container for submerging the workpiece and the tool in a non-dielectric chemical fluid.

20. The system as claimed in claim 16 further comprising an X-Y stage for the workpiece holder for moving a container for a silicon workpiece and a Z stage for the tool holder for moving the tool and the workpiece relative to each other for electro discharge machining down to distances less than 0.1 μm.
